(19) United States
(12) Patent Application Publication
(10) Pub. No.: US 2007/0067954 A1
(43) Pub. Date: Mar. 29, 2007

(54) Hinge apparatus and methods therefor

(76) Inventors: Benjamin M. Finney, Cary, NC (US); Brian J. Hassemer, Gurnee, IL (US); Gary R. Weiss, Buffalo Grove, IL (US); Christopher P. Carlson, Mundelein, IL (US)

Correspondence Address: MOTOROLA INC, 600 NORTH US HIGHWAY 45, ROOM AS437, LIBERTYVILLE, IL, 60048-5343, US

(21) Appl. No.: 11/237,102

(22) Filed: Sep. 28, 2005

(51) Int. Cl. E05D 7/04

(52) U.S. Cl. 16/235

(57) ABSTRACT

A collapsible housing including a first housing having a magnetic member (108) carried by the first housing (110). A slide enabling member (104) is rotatably coupled to the first housing by a hinge (102), the slide enabling member rotating about a rotation axis (106) of the hinge and, the slide enabling member extending radially from the rotation axis. A second housing (120) is slideably coupled to the slide enabling member such that the second housing slides along the slide enabling member. The housing further includes an engaging member (112) carried by the second housing and selectively engageable to the magnetic member. A first urging member (118) is coupled between the first housing and the slide enabling member, the first urging member urging the slide enabling member to rotate about the rotation axis relative to the first housing. A second urging member (122) is coupled between the second housing and the slide enabling member, the urging member urging the second housing to laterally slide along the slide enabling member in a radial direction relative to the rotation axis.

### CROSS REFERENCE TO RELATED APPLICATIONS

This application is related to the following co-pending application “Hinge Apparatus And Methods Therefor” Ser. No. 10/930,104, filed 31 Aug. 2004; which is assigned to the assignee of the present application and incorporated herein by reference.

### FIELD OF THE INVENTION

The present invention relates generally to a closeable devices and, more particularly to automatic opening and closing mechanisms.

### BACKGROUND OF THE INVENTION

Foldable devices often include a hinge with a spring to assist in either opening or closing the device. For example, handheld cellular telephones have a clamshell (i.e. collapsible or closeable) style housing wherein first and second housing portions couple together using a hinge at an upper end portion of the device. These devices generally have a torsion spring or the like to assist in opening the device. Also known are devices wherein the flip portion of the housing slides, relative to the second housing. These devices however lack automatic opening and closing mechanisms that are easy to use.

Some devices employ a spring loaded hinge to assist in opening and closing operation. Some devices maintain the closed position with detents or cams that are incorporated into the hinge portion of the device. One device employs a magnetic field that may be turned on and off selectively to allow the device to open. When on, the magnetic field generated in on housing, attracts a magnetically attracted material such as another magnet or a ferrous material of the another housing to hold the device closed. The device may be opened or is disengaged when the magnetic field is turned off. However, this magnetic engagement requires the operation of toggling the magnetic field on or off to open and close the device.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an exemplary cross sectional view of a device having a hinged portion in a first closed position configuration.

FIG. 2 is an exemplary cross sectional view of the device having a hinged portion in a second closed configuration.

FIG. 3 is an exemplary cross sectional view of the device having a hinged portion in an open configuration.

FIG. 4 is an exemplary cross sectional top view of a hinge portion and slide enabling member.

FIG. 5 is an exemplary cross sectional top view of a hinge portion and slide enabling member.

FIG. 6 is an exemplary perspective view of the device in an open configuration.

FIG. 7 is an exemplary cross sectional view of a device having a hinged portion and a repelling magnet.

FIG. 8 is an exemplary dampening member.

FIG. 9 is an exemplary dampening member.

FIG. 10 is an exemplary dampening member.

FIG. 11 is an exemplary cross sectional view of the device having a hinged portion, a slide enabling member and a cam.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

While the present invention is achievable by various forms of embodiment, there is shown in the drawings and described hereinafter several examples of embodiments with the understanding that the present disclosure is to be considered an exemplification of the invention and is not intended to limit the invention to the specific embodiments contained herein as will become more fully apparent from the discussion below. It is further understood that the hinge mechanisms of the present invention may be used more generally in any application where it is desirable to provide a collapsible device.

A collapsible housing is disclosed that includes a first housing and a second housing. A hinge is coupled to the first housing, the hinge having a rotation axis. A slide enabling member is rotateably coupled to the hinge and extends substantially radially therefrom. The second housing is slideably coupled to the slide enabling member. The hinge allows the slide enabling member, and the second housing, to rotate relative to the first housing about the rotation axis of the hinge. The hinge is configured to allow the first and second housing to fold and unfold from an open configuration to a collapsed or closed configuration. The second housing moves radially relative to the hinge and laterally relative to the slide enabling member. In the collapsed or closed configuration the second housing slides laterally relative to the first housing from a first closed configuration to a second closed configuration. From the second closed configuration the slide enabling member (and second housing coupled thereto) may rotate relative to the first housing about the rotation axis to an open configuration. The second housing may automatically slide radially between a first radial position and a second radial position as the second housing rotates from a first rotation configuration to a second rotation configuration.

A magnetic member is carried by the first housing. An engaging member is carried by the second housing and selectively engageable to the magnetic member. When positioned in the first closed configuration the magnetic member and the engaging member are magnetically engaged or attracted thereby holding the first housing and the second housing together. A first urging member coupled between the first housing and the slide enabling member urges the slide enabling member to rotate about the rotation axis relative to the first housing by a first urging member force. A second urging member coupled between the second housing and the slide enabling member urges the second housing to slide along the slide enabling member.

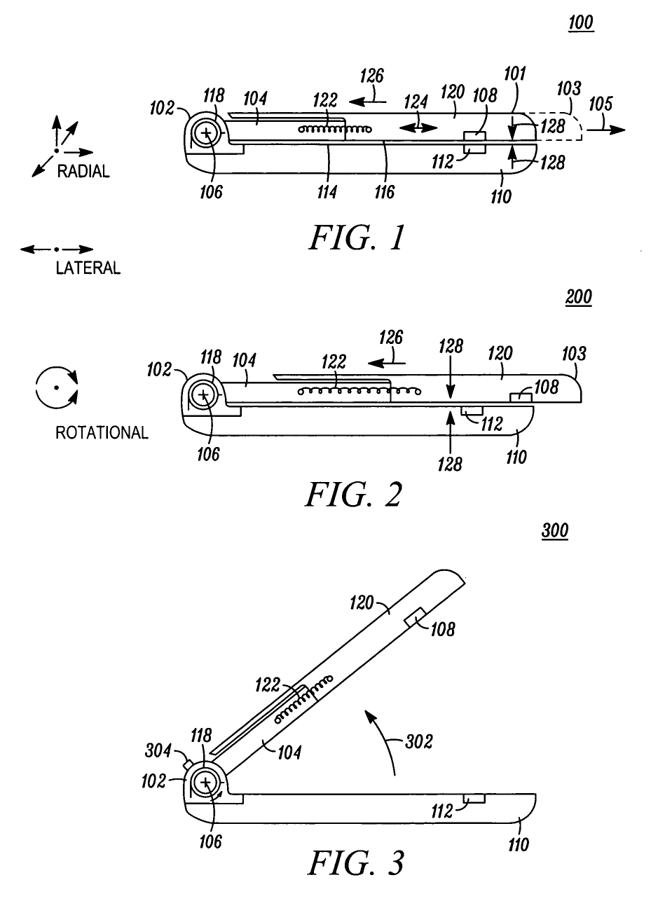

FIG. 1 is an exemplary cross sectional view of a device having a hinged portion and illustrates the exemplary collapsible electronic device in a closed configuration 100. In this exemplary embodiment, the device is an electronic device such as a radiotelephone. The radiotelephone described herein is a representation of the type of wireless communication device that may benefit from the present invention. However, it is to be understood that the present invention may be applied to any type of hand-held or portable device including, but not limited to, the following devices: radiotelephones, cordless phones, paging devices, personal digital assistants, portable computers, pen-based or keyboard-based handheld devices, remote control units, portable media players (such as an MP3 or DVD player) and the like. Accordingly, any reference herein to the radiotelephone 100 should also be considered to apply equally to other hand-held or portable electronic devices.

The device is shown in the exemplary closed configuration 100 wherein a first housing 110 is planarly adjacent (i.e. stacked) to a second housing 120. The first housing 110 is hingedly coupled to the second housing 120 by a hinge 102 which has a rotation axis 106. The hinge 102 is coupled to a slide enabling member 104 in addition to the first housing 110. The second housing 120, for example a radiotelephone flap, is moveably coupled to the slide enabling member 104. The hinge 102 couples the first housing 110 to the slide enabling member 104 and effectively to the second housing 120, allowing the second housing 120, via the slide enabling member 104, to rotate relative to the first housing 110 about the rotation axis 106.

Movement of the second housing 120 may be discussed as lateral movement relative to the slide enabling member 104 or radially movement relative to the hinge 102 or rotation axis 106. The slide enabling member 104 allows the second housing 120 to slide laterally along the slide enabling member 104 in the direction indicated by the arrow 105 from a retracted position 101 to an extended position 103. Relative to the hinge 106, the second housing slides radially along the slide enabling member 104 from a first radial position to a second radial position. As the second housing 120 rotates about the rotation axis 106, the second housing 120 may slide along the slide enabling member 104. In one embodiment, the position of the second housing 120 relative to the slide enabling member 104 is a function of the angle of rotation about the rotation axis 106 as will be discussed later.

A hinge urging member 118 is coupled between the first housing 110 and the slide enabling member 104. In this embodiment, the hinge urging member 118 is a component of the hinge 102. The hinge urging member 118 urges the slide enabling member 104 to rotate about the rotation axis 106 relative to the first housing 110 thereby angularly displacing the second housing 120 relative to the first housing 110. In one embodiment, the hinge urging member 118 automatically causes the second housing 120 to rotate about the rotation axis 106. In an alternate embodiment, the hinge urging member 118 assists the rotation of the second housing 120 about the rotation axis 106. As a matter of design, the amount of torque produced by the hinge urging member 118 determines whether the second housing 120 will rotate automatically from the second closed configuration 200, shown in FIG. 2 or not. For example, the amount of torque may be such that the user must initiate the automatic rotation of the second housing 120 to open the device. Once the user initiates the rotation, the hinge urging member 118 takes over and automatically rotates the second housing 120 to the desired open configuration.

A slide urging member 122 is coupled between the second housing 120 and the slide enabling member 104. The slide urging member 122 urges, by a slide urging member urging force 126, the second housing 120 to automatically slide along the slide enabling member 104 in a lateral direction 124 relative to the slide enabling member 104. In this exemplary embodiment the slide urging member 122 is configured to laterally urge the second housing 120 automatically toward the retracted position 101 (i.e. from the extended configuration 103, the second housing 120 moves to the retracted position 101 automatically). Alternatively the slide urging member 122 may urge the second housing 120 away from the rotation axis 106 toward the extended position 103.

The second housing 120 carries a magnetic member 108. In this exemplary embodiment, the magnetic member 108 is a first magnet but may alternatively be an electromagnet or the like. The first housing 110 carries an engaging member 112 that is magnetically engageable to the magnetic member 108. The engaging member 112 is configured such that the first magnet 108 and the engaging member 112 are attracted to one another when substantially aligned in the first closed configuration 100. One of ordinary skill in the art will appreciate that the attraction force between magnets and engaging members varies and the magnitude of the attractive force 128 therebetween is dependant upon inter alia separation distance of the two members. In the embodiment shown, the engaging member 112 is a second magnet, configured to be attracted to the magnetic member 108 (i.e. the north pole of one magnet is oriented to face the south pole of the other magnet). The magnetic member 108 and the engaging member 112 are each carried near or at the surface of their respective housings, positioned accordingly to achieve the desired attractive force 128 therebetween. The engaging member 112 may also be a metallic member that is attracted to the magnetic member 108. In an alternate embodiment the engaging member 112 is a ferrous material.

In this exemplary embodiment, the first housing 110 shown has an elongated shape with at least a first face 114. The second housing 120 has a similar elongated shape with a second face 116. In the first closed configuration 101, the second housing 120 substantially covers the first face 114 of the first housing 110 wherein the first face 114 and the second face 116 are substantially planarly adjacent. The housings do not have to be substantially the same shape as in the embodiment shown. For example, the second housing 120 may be a cover that merely covers a portion of the first housing, e.g. to protect a keypad and/or display carried on the first housing 110. In the one exemplary embodiment shown, the first housing 110 rotates relative to the second housing 120 about the rotation axis 106 which is substantially in the same plane as at least the first face 114 of the first housing 110. In the exemplary embodiment shown in FIG. 1, the first and second housings 110, 120 are adapted to carry electronics. In alternate embodiments the device is a toy that does not have electronic components.

FIG. 2 is an exemplary cross sectional view of the device having a hinged portion illustrating the device in a second closed configuration 200 with the second housing 120 in the extended configuration 103. In this embodiment, the second housing 120 has been slid radially relative to the rotation axis 106 and laterally relative to the first housing 110 as indicated by arrow 105, shown in FIG. 1 to the second closed position 200.

Moving the second housing 120 toward the second closed position 103 displaces the magnetic member 108 away from the engaging member 112 such that the attractive force 128 between the two members 108, 112 is reduced. In this embodiment, the magnetic member 108 moves laterally away from the first engaging member 112 effectively disengaging from the engaging member 112 and allowing the second housing 120 to rotate freely about the rotation axis 106. The second housing may automatically begin to rotate once the torque of the hinge urging member 118 overcomes the attractive force 128 of the magnetic member 108 and the engaging member 112. For example, sliding the second housing 120 to the extended configuration 103 such that the magnetic member 108 moves away from the engaging member 112, allows the second housing 120 to begin to rotate to an open configuration due to the torque of the hinge urging member 118. Alternatively, the rotation from the second closed configuration 200 may be assisted, or at least initiated by an additional force such as a user's hand or a repelling magnetic force as discussed later.

FIG. 3 shows a cross sectional view of the device in an exemplary open position 300. In the open position 300, the second housing 120 is angularly displaced 302 from the first housing 110 about the rotation axis 106 of the hinge 102. In this embodiment, the hinge is coupled at a top edge of the first housing 110 and effectively, through the slide enabling member 104 to the top edge of the second housing 120. The angle of the second housing 120 relative to the first housing 110 that is shown is merely exemplary and it is to be understood that the angle about the rotation axis 106 varies. In this embodiment, the slide urging member 122 urges the second housing 120 laterally along the slide enabling member 104 back toward the retracted position 101 shown in FIG. 1.

The second housing 120 may open and stop at a fixed angle appropriate for operation in accordance with the device type and it is to be understood that this is a choice of design. For example, the angle of displacement may be 180 degrees or 90 degrees, as one skilled in the art will understand that various angles may embody the present invention. In one embodiment, the open configuration angle is achieved with a mechanical stop 304. The mechanical stop 304 in this embodiment, comes into contact with the second housing 120 and acts against the torque of the hinge urging member 118 preventing further rotation of the second housing 118. The mechanical stop 304 may be a portion of the first housing 110, such as the hinge 102 (hinge barrel) that comes into contact with the second housing 120 as shown in this embodiment. Alternatively, the mechanical stop is incorporated into the hinge 102 such as a leaf spring, cam or the like.

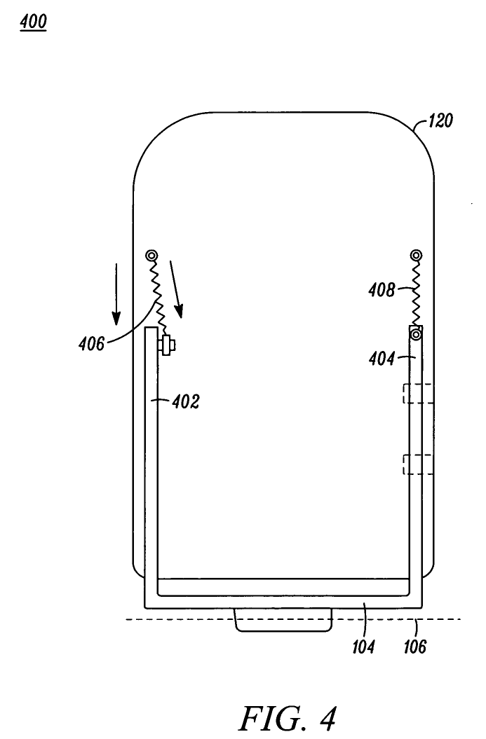

FIG. 4 shows an exemplary cross sectional top view of the slide enabling member 104 with the second housing 120 in the retracted position 400. In this embodiment, the slide enabling member 104 comprises two rails, a first rail 402 and a second rail 404. The second housing 120 slides laterally along the first and second rails 402, 404. Two slide urging members are provided in this embodiment, a first slide urging member 406 and a second slide urging member 408. Each slide urging member is coupled between the second housing 120 and each rail; the first slide urging member 406 is coupled to the first rail 402 and the second slide urging member 408 is coupled to the second rail 404.

The first rail 402 and the second rail 404 may be formed as one part with the hinge shaft (not shown) or as separate component coupled to the hinge shaft. In this one exemplary embodiment, the rails 402 and 404 extend radially from the rotation axis 106 and rotate about the rotation axis 106. Both urging members 406, 408 urge the second housing 120 in the same direction, i.e. pulling the second housing 120 toward the rotation axis 106. Both urging members are compression springs in this embodiment; however, it is to be noted that other springs or urging members may be used. Further, one spring may be a compression spring and the other an extension spring for example; the springs configured relative to one another so as to move the second housing 120 in the same direction relative to the slide enabling member 104.

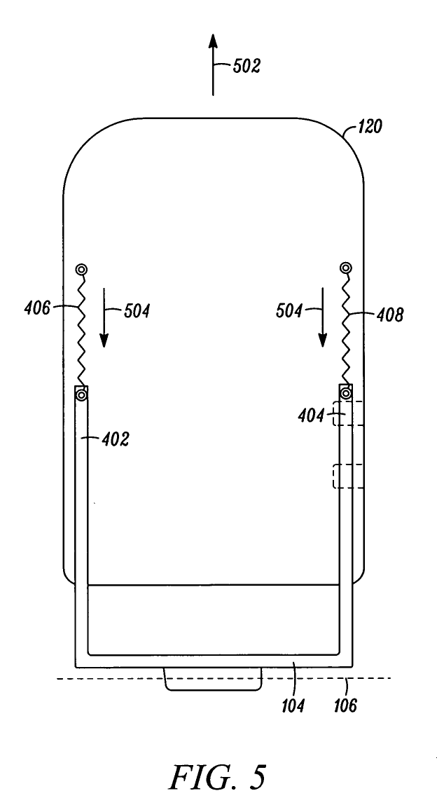

Each of the urging members 406, 408 in this exemplary embodiment are coupled to the second housing 120 by a post extending therefrom and to a post extending from the rails 402, 404. The urging members 406, 408 may be coupled to the housing and the rails by a screw, tab, clip or the like. Those of ordinary skill in the art will appreciate that there are numerous ways to attach the spring to both a rail and the second housing 120. The urging members in FIG. 4 and FIG. 5 are shown coupled to the rails in two different configurations for illustration purposes only. They may not be coupled in different manners as illustrated. In FIG. 4, the first urging member 406 is coupled to a side of the rail 402 and the second urging member 408 is coupled to the top of the second rail 404.

FIG. 5 illustrates the second housing 120 in the extended position, indicated by arrow 502 with both the first urging member 406 and the second urging member 408, extended. The urging member force of each urging member, acts to urge the second housing in the direction indicated by arrows 504. In the embodiments illustrated in FIG. 4 and FIG. 5, the first and second urging members 406, 408 are extension springs. In an alternate embodiment the springs are compression spring, and the springs would urge the second housing 120 by a pushing force due to the tendency of the compression spring to extend from its compressed state.

As discussed, the first and second slide urging members 406, 408 may be a set of springs. Alternatively, the slide urging members may be resilient members or magnetic members for example. The springs may be a compression spring or an extension spring. The resilient member may be rubber material or the like that has compressible characteristics. The magnetic set of members may be a pair of magnets, electro magnets or a magnet and a metallic or ferrous material attracted to the magnet.

In the embodiment wherein the slide urging member is a magnetic member, a first magnetic member is carried in the second housing 120. A second magnetic member may be carried at or substantially near the hinge 102 thereby urging the second housing 120 toward the retracted position 101, 400. The second engaging member may also be carried on the slide enabling member 104.

A resilient member such as rubber would act similar to the extension spring. The resilient member would urge the second housing 120 by the pushing force due to the tendency of the resilient member to extend from its compressed state.

The interaction of the hinge urging member 118 and the slide urging member 122 with the first and second housings 110, 120 is described with reference to FIG. 1 through FIG. 5. The first housing 110 and the second housing 120 are held together by the magnetic member 108 and the engaging member 112 in the first closed configuration 100. To open the device, the second housing 120, is slid 105 against the slide urging member urging force 126, laterally relative to the first housing 110 from the first closed configuration 100, to the second closed configuration 200. This lateral movement displaces the magnetic member 108 from the engaging member 112 and as the attractive magnetic force reduces, the torque exerted by the hinge urging member 118 of the hinge 102 overcomes the attractive magnetic force 128. As a result of the torque, the second housing 120 rotates, or is urged to rotate, relative to the first housing 110 about a rotation axis 106 of the hinge 102.

An exemplary method for closing the device comprises manually collapsing (i.e. folding) the device by rotating, from the open configuration 300, the second housing 120 relative to the first housing 110 about the rotation axis 106 to a closed configuration 100, for example, wherein the first housing 110 and the second housing 120 are substantially planarly adjacent. The second housing 120 is urged toward the retracted position 101 as the second housing 120 approaches the closed configuration 100. In this embodiment, the method includes sliding the second housing 120 automatically, as a result of the urging member urging force 126, laterally along the slide enabling member 104 to the retracted position 101 as the second housing 120 approaches the closed configurations 100 (or substantially zero degree angle). When the device reaches the first closed position 100, the first housing 110 and the second housing 120 are substantially aligned longitudinally in this embodiment. The slide urging member 122 moves the second housing 120 to the retracted position 101 and thereby aligning the magnetic member 108 with the magnetic engaging member 112 such that the attractive force 128 of the magnetic member 108 and the magnetic engaging member 112 automatically holds the first housing 110 and the second housing 120 in the first closed configuration 100.

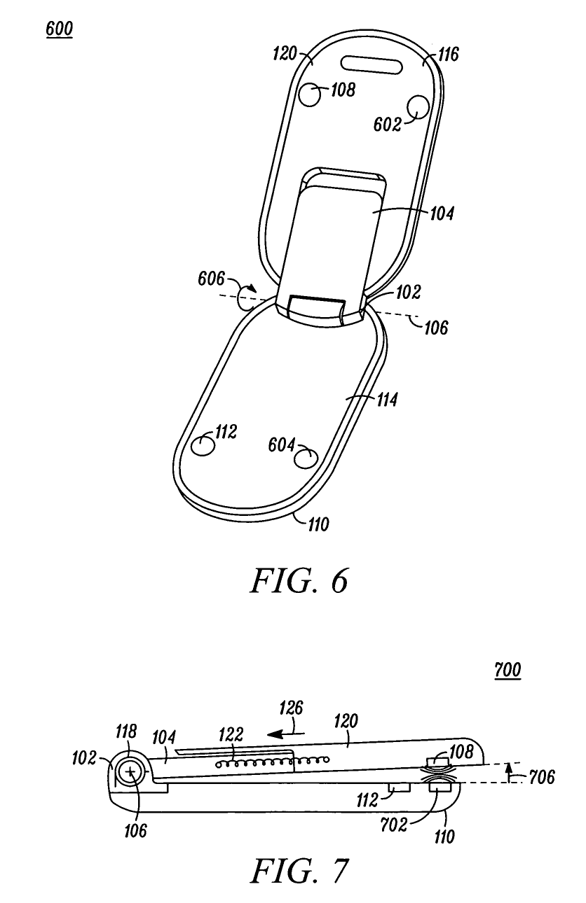

FIG. 6 shows a perspective view of the exemplary embodiment in a open configuration 600. This open configuration 600 is such that the second housing 120 is rotated, in the direction indicated by arrow 606, to an angle that is conducive to telephone operation for example. In this embodiment, in addition to the first magnetic member 108 and the first engaging member 112, a second magnetic member 602 and a second engaging member 604 are carried by the device as an alternative to one magnetic pair. In this embodiment, the first magnetic member 108, as illustrated in the embodiment of FIG. 1, and the second magnetic member 602 are carried in the second housing 120. Additionally, in the exemplary embodiment, the first engaging member 112 and a second engaging member 604 are carried in the first housing 110. The second engaging member 604 is selectively engageable to the second magnetic member 602 to compliment the first magnetic member 108 and the first engaging member 112 and provide additional magnetic force to hold the first housing 110 to the second housing 120. The two pairs of magnetic members may be useful because, as the space available in the housings may be limited which in turn limits the size for the magnetic members 108, 602.

FIG. 7 illustrates a repelling magnet 702 which may be carried on the first housing 110. The repelling magnet 702 is configured to repel or be repelled by the magnetic member 108. The repelling magnet 702 is carried on the first housing 110 at a location such that when the second housing 120 is laterally slid (arrow 105) to the second closed configuration 200, 700, the magnetic member 108 is substantially adjacent to the repelling magnet 702. The repelling effect of the magnetic member 108 and the repelling magnet 702 causes the second housing 120 to rotate and begin to open, indicated by arrow 706 about the rotation axis 106 of the hinge 102. In one embodiment wherein the hinge 102 includes the first urging member 118 such as torsion spring, to cause the second housing 120 to rotate to the first open configuration 200 relative to the first housing 110, the magnetic repelling force of magnetic member 108 and the repelling magnet 702 is complimentary to the spring force (i.e. the torque), also causing rotation about the rotation axis 106 from the second closed position 200 to the open configuration 300. The magnetic field (i.e. creating the repelling force) of the repelling magnet 702 and the interaction with the magnetic field of the magnetic member 108 assist the first urging member 118, and the user, when opening the device. In the embodiment wherein the second magnetic member 602 is present, a second repelling magnet may be carried on the first housing 110.

It is to be understood that the magnetic members, the engaging members and repelling members may be arranged in a plurality of configurations in and between the housings although the functions remain the same. For example, in the embodiment wherein the engaging members are not magnets but metallic members, the first magnetic member may be located on (i.e. carried by) the second housing 120 and the first engaging member 112 may be carried on the first housing 110. The repelling magnet 702 would also then be carried on the second housing 120.

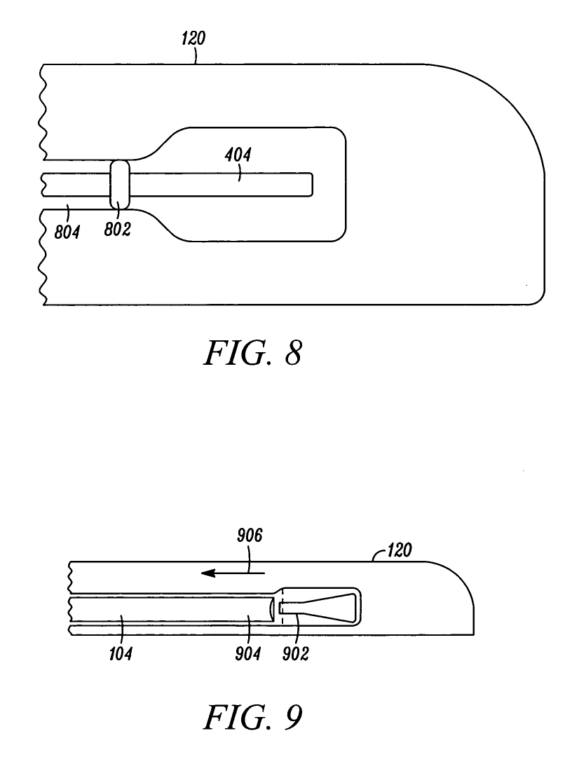

One exemplary embodiment, illustrated in FIG. 8, shows at least one of the rails 404 with a slide dampening member 802. The slide dampening member is coupled to the slide enabling member 404 and selectively engageable with the rail engaging portions of the second housing 120. The slide dampening member 802 dampens or slows the movement of the second housing 120 as it slides along the rails. In this exemplary embodiment, the dampening occurs as the second housing 120 slides toward the retracted, drawn back or inward, position 101 shown in FIG. 1. The dampening may not occur over the entire length of travel in this embodiment, but as it reaches one end of travel. For example the dampening may occur as the second housing 120 approaches the retracted position 101. The dampening may occur however at any position between the extended position 103 and the retracted position 101 and may occur in either or both directions of travel.

The slide dampening member may be a bushing, an o-ring a plug or a coating coupled to at least one of the rails. The embodiment shown in FIG. 8 illustrates the bushing or o-ring carried on the slide enabling member 404. The bushing 802 selectively engages the bushing engaging portion 804 of the second housing 120.

The slide dampening member may alternatively comprise a tapered, compressible plug, and flare the end of a tube of the second housing 120. FIG. 9 illustrates a tapered resilient member 902 and a hollow or flared portion 904 of the slide enabling member 104. During retraction, indicated by arrow 906 (or extension in another embodiment not shown) i.e. sliding the second housing 120 to the retracted position 101, the tapered resilient compressible plug wedges into the flared tube and resists the second urging member urging force. A spring, such as a compression spring, may take the place of the tapered compressible plug in another exemplary embodiment.

The slide dampening member may also be comprised of material painted on one of the rails, or a second housing portion that engages the rail, which has a bushing effect when the rail engages the second housing. For example, the material may be a rubber material applied to the rail 402, 404. The slide dampening member may also comprise at least one spring clip selectively coupled to the rail.

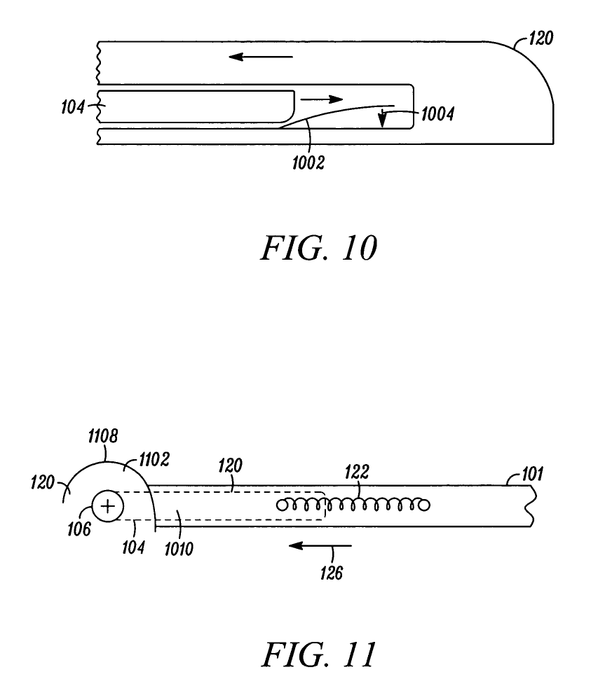

FIG. 10 illustrates a spring finger 1002 which deflects in the direction indicated by arrow 1004. The dampening effect occurs when the rail engages the spring clip as the rail slides from one of the retracted position 101 to the extended position 103 or from the extended position 103 to the retracted position 101.

Illustrated in FIG. 11 is an example of one embodiment including a cam 1102. The cam 1102 illustrated in FIG. 11 is exaggerated the clarity sake and is not necessarily to scale. The cam 1102 positions the second housing 120 laterally relative to the slide enabling member 104. The position of the second housing 120 relative to the slide enabling member 104, the rotation axis 106 or both is dependent upon the rotation position (i.e. angular displacement) of the second housing 120 relative to the first housing 110 about the rotation axis 106.

In this exemplary embodiment, the cam 1102 acts in a direction opposite the slide urging member force 126. The cam 1102 positions the second housing 120 laterally along the slide enabling member 104 while the slide urging member 122 urges the second housing 120 to maintain contact with the cam 1102. The cam 1102 allows the second housing 120 to retract to the retracted position 101. In another exemplary embodiment, the cam 1102 causes the second housing 120 to move from the extended position 103 to the retracted position 101 as the second housing 120 rotates to the open configuration 600. This prevents the second housing from snapping to the retracted position 101 from the extended position 103 during the opening operation. Additionally, as the second housing 120 is rotated from the open configuration 600, for example, to the first closed configuration 100, the cam 1102 positions the second housing 120 along the slide enabling member 104, in conjunction with the slide urging member 122, to the retracted configuration 101.

In another exemplary embodiment, the second housing 120 selectively engages the cam 1102 as the second housing 120 rotates about the rotation axis 106 and thereby radially positions the second housing 120 along the slide enabling member 104 as the second housing 120 rotates about the rotation axis 106. For example, the cam 1102 may disengage (not shown) from the second housing 120 when the device is in the closed configuration 100.

The cam 1102 has a surface 1108 wherein the second housing 120 translates over the surface 1108 of the cam 1102 as the second housing rotates about the rotation axis 106 relative to the first housing 110. The second housing 120 may have follower 1110 which is a tab extending from the second housing to engage the surface 1108 of the cam 1102. The follower may have a reduced friction surface such as Teflon or the like or bearing characteristics that such that the follower slides in contact with the surface 1108, and the resulting frictional force does not overcome the urging force of the hinge urging member 118.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A portable handheld device comprising:
a first housing;
a magnetic member carried by the first housing;
a slide enabling member rotatably coupled to the first housing by a hinge, the slide enabling member rotating about a rotation axis of the hinge and, the slide enabling member extending radially from the rotation axis;
a second housing slideably coupled to the slide enabling member such that the second housing slides along the slide enabling member;
an engaging member carried by the second housing and selectively engageable to the magnetic member;
a hinge urging member coupled between the first housing and the slide enabling member, the first urging member urging the slide enabling member to rotate about the rotation axis relative to the first housing; and
a slide urging member coupled between the second housing and the slide enabling member the second urging member urging the second housing to slide along the slide enabling member in a radial direction relative to the rotation axis.

2. The device of claim 1, wherein the second housing slides radially between a first radial position and a second radial position as the second housing rotates from a first rotation configuration wherein the second housing is angularly displaced relative to the first housing to a second rotation configuration.

3. The device of claim 2, wherein the magnetic member is adjacent to the engaging member when the second housing is planarly adjacent to the first housing in the second rotation position and the second housing is at the first radial position along the rail.

4. The device of claim 3, wherein the magnetic member is displaced from the engaging member when the second housing is planarly adjacent to the first housing in the second rotation position and the second housing is at the second radial position along the rail.

5. The device of claim 4, wherein the first radial position of the second housing is a retracted position and the second radial position of the second housing is an extended position.

6. The device of claim 1, wherein the engaging member is a second magnetic member attracted to the first magnetic member.

7. The device of claim 1, wherein the engaging member is a metallic member attracted to the magnetic member.

8. The device of claim 1, further comprising a cam carried on the first housing and selectively engageable to the second housing.

9. The device of claim 8, wherein the cam variably positions the second housing radially along the slide enabling member as a function of the angular displacement of the first housing relative to the second housing about the rotation axis.

10. The device of claim 8, wherein the slide urging member urges the second housing to be adjacent to the cam.

11. The device of claim 8, further comprising a follower carried on the second, the follower selectively engaging the cam.

12. The device of claim 8, wherein a cam surface of the cam is formed by an outer surface of a hinge barrel housing the hinge.

13. The device of claim 1, wherein the slide enabling member is at least one rail.

14. The device of claim 1, the hinge urging member is a spring.

15. The device of claim 14, wherein the spring is at least one of a compression spring and an extension spring.

16. The device of claim 14, wherein the resilient member is rubber member.

17. The device of claim 1, further comprising a repelling magnet carried on the first housing which is configured to be magnetically repelled by the magnetic member when the magnet member and the repelling magnet are substantially adjacent.

18. The device of claim 1, wherein the hinge urging member urges the second housing to angularly displace relative to the first housing to an open configuration.

19. The device of claim 1, wherein an attraction force of the magnetic member and the engaging member is greater than a hinge urging member force, such that the magnetic member and the engaging member hold the first housing and the second housing in a closed configuration when substantially aligned.

20. The device of claim 1, the hinge urging member urging the second housing to a closed configuration relative to the first housing.

21. The device of claim 1, a slide dampening member coupled to the slide enabling member and selectively engageable with the second housing.

22. The device of claim 21, wherein the slide dampening member reduces the sliding velocity of the second housing portion along the rail at a position between a fully extended position and a fully retracted position.

23. The device of claim 22, wherein the slide dampening member is at least one of a bushing, an o-ring, a plug and a coating.

24. The device of claim 22, wherein the dampening means comprises a tapered, compressible plug, and a flare end of a tube of the second housing.

25. The device of claim 22, wherein the dampening means comprises material painted on at least one of the rail and a second housing portion that engages the rail that has a bushing effect when the rail engages the second housing.

26. The device of claim 22, wherein the dampening means comprises at least one spring clip selectively coupled to the rail.

27. A method of opening a collapsible device comprising:
sliding a second housing, against a slide urging member urging force, laterally relative to a first housing from a retracted position,
to an extended position displacing a magnetic member carried on the first housing from a magnetic engaging member carried on the second housing such that a torque exerted by a hinge urging member of a hinge overcomes an attractive magnetic force between the magnetic member and the magnetic engaging member; and
rotating, as a result of the torque, the second housing relative to the first housing about a rotation axis of the hinge.

28. The device of claim 27, further comprising aligning a second magnetic engaging member carried on the second housing configured to be magnetically repelled by the magnetic member when the magnet member and the second engaging member are substantially adjacent in the second closed position.

29. A method of closing a collapsible device comprising:
rotating the second housing relative to the first housing about a rotation axis to a closed configuration wherein the first housing and the second housing are substantially planarly adjacent;
sliding the second housing automatically as a result of an urging member urging force laterally along a slide enabling member to a retracted position as the second housing approaches the closed configuration; and
aligning a magnetic member with a magnetic engaging member such that the attractive force of the magnetic member and the magnetic engaging member hold the first housing and the second housing the closed configuration.
